(19) United States
(12) Patent Application Publication
(10) Pub. No.: US 2006/0166520 A1
(43) Pub. Date: Jul. 27, 2006

(54) Connecting assembly

(76) Inventors: George Marmaropoulos, Yorktown Heights, NY (US); Giang Vu, New York, NY (US); Katharine Pulford, Hackney (GB)

Correspondence Address: PHILIPS INTELLECTUAL PROPERTY & STANDARDS, P.O. BOX 3001, BRIARCLIFF MANOR, NY, 10510, US

(21) Appl. No.: 10/560,711

(22) PCT Filed: Jun. 25, 2004
(86) PCT No.: PCT/IB04/51014

§ 371 Date: Dec. 15, 2005

Related U.S. Application Data
(60) Provisional application No. 60/483,772, filed on Jun. 30, 2003.

(51) Int. Cl. H01R 33/00

(52) U.S. Cl. 439/37

(57) ABSTRACT

There is provided a flexible, lightweight high-performance interconnect (1) that can cooperate with a variety of different textiles in the form of garments and/or upholsteries (60) for example, as well as with any of a variety of different electronic devices/systems (50) without compromising the innate characteristics (e.g., the comfort or durability) of the textile. The interconnect (1) having at least one male element (10) and at least one female element (20) with a textile construction cooperative with the at least one male element (10) providing a secure and safe mechanical and/or electrical connection.

The present invention relates to textile electronics. More particularly, the present invention relates to a connecting assembly or a textile interconnect having at least one male element with one or more contact elements and at least one female element fashioned from a flexible fiber construction.

The use of electronics in various manufactured materials is well known; see for example, U.S. Pat. Nos. 6,360,615 B1, 6,210,771 B1, and 5,371,326; U.S. Patent Application Publication Nos. 2002/0135457 A1 and 2002/0076949 A1; PCT International Patent Publication Nos. WO 02/055923 A1 and WO 02/32665 A1; and/or UK Patent Application No. GB 2 373 863. Devices such as conductive traces, bio-sensors, electrodes, computers, electronic circuits and the like have all been incorporated into textiles. As the benefits associated with the various types and/or configurations of textile electronics become more apparent, the desirability and need for simple, effective and efficient, as well as intuitive electronic interconnecting solutions becomes more apparent. Hence, there is a need for an interconnect that is complementary to the various electronic devices/systems associated with the various textile electronics and/or the materials accommodating such electronics.

It is an object of the present invention to provide a connecting assembly or an interconnect suitable to address the above-identified need for simple, effective and efficient, as well as intuitive textile interconnect solutions.

It is another object of the present invention to provide such an interconnect that provides a secure and effective mechanical and/or electrical connection.

It is another object of the present invention to provide such an interconnect that has cooperative male and female elements with one or both of such elements having a textile construction.

It is another object of the present invention to provide such an interconnect that has cooperative male and female elements with one or both of such elements being adjustable to facilitate a secure mechanical and/or electrical connection.

It is another object of the present invention to provide such an interconnect having a controller operative to accomplish the adjusting of the male and/or female elements.

It is another object of the present invention to provide such an interconnect that is cooperative with a garment, with upholstery and/or with one or more electronic devices/systems.

It is another object of the present invention to provide such an interconnect that is suitable to provide a secure mechanical and/or electrical connection between and/or among various textile electronics.

These and other objects and advantages of the present invention are achieved by a connecting assembly or interconnect having at least one male element with one or more adjustable connecting or contact members and at least one female element with one or more connecting or contact areas cooperative with the one or more contact members of the at least one male element. The at least one female element is preferably of a flexible textile construction. Thus, the interconnect preferably provides for a soft, flexible mechanical and/or electrical connection for various textile electronic devices/systems and corresponding materials.

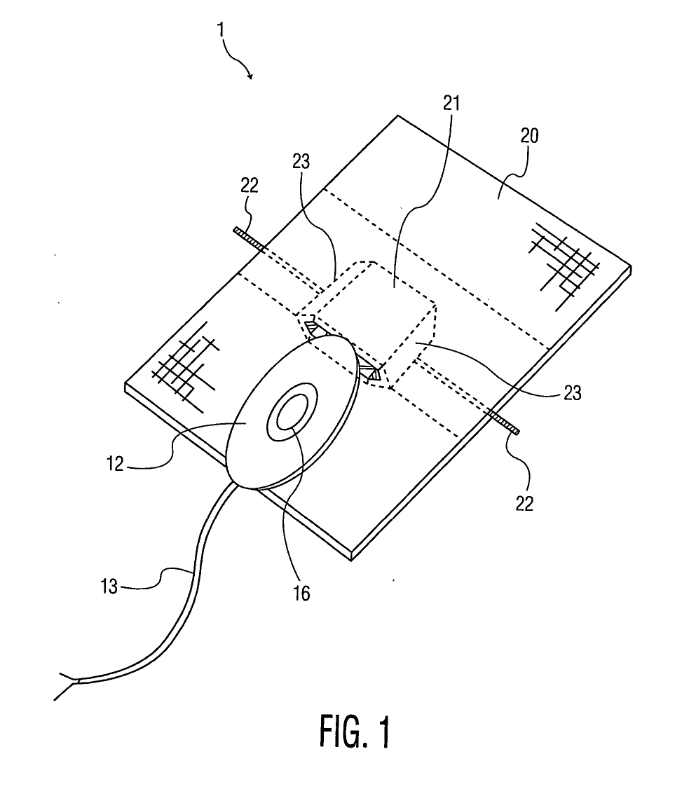

FIG. 1 is a perspective view of a male and a female element of a connecting assembly or an interconnect in accordance with an illustrative embodiment of the present invention;

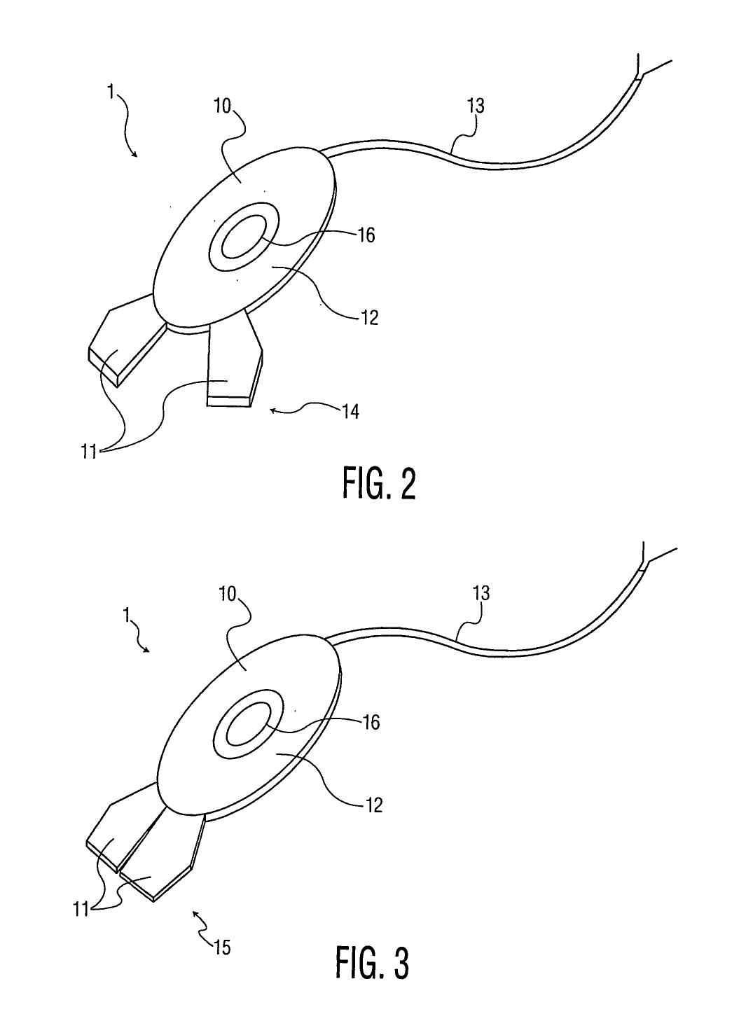

FIG. 2 is a perspective view of the male element of FIG. 1, showing the male member in a first state;

FIG. 3 is a perspective view of the male element of FIG. 1, showing the male member in a second state;

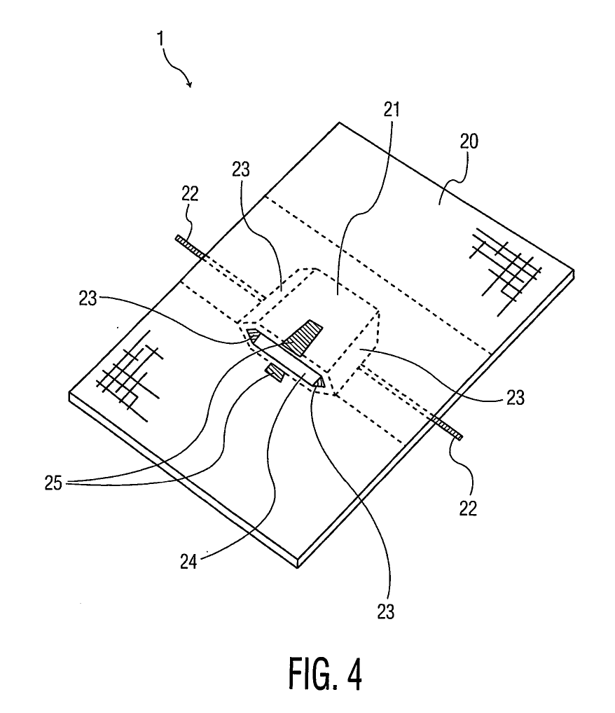

FIG. 4 is a perspective view of the female element in accordance with an illustrative embodiment of the present invention;

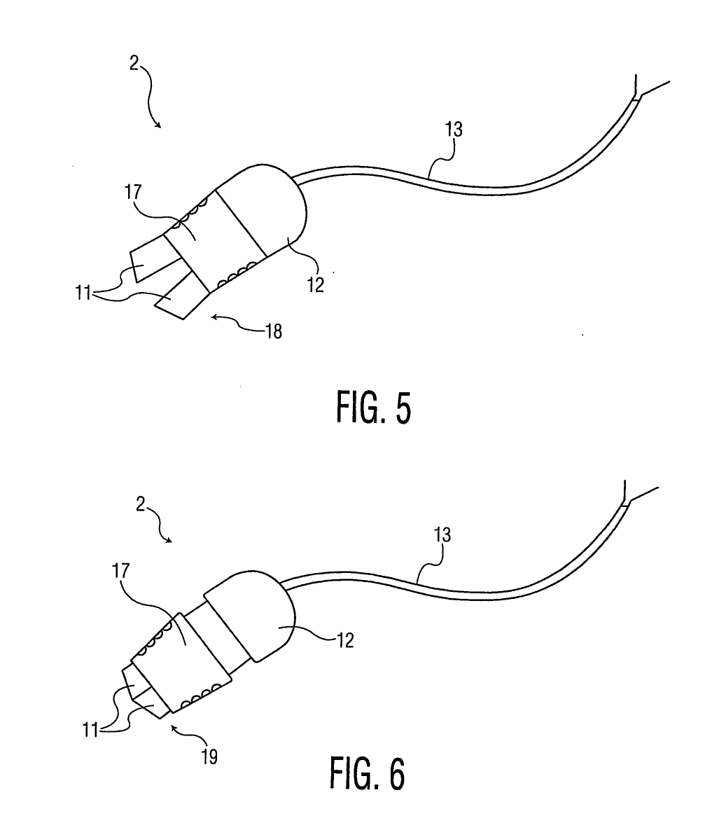

FIG. 5 is a plan view a male element of a connecting assembly or an interconnect in accordance with another illustrative embodiment of the present invention, showing the male element in a first state;

FIG. 6 is a plan view of the male element of the interconnect of FIG. 5, showing the male element in a second state;

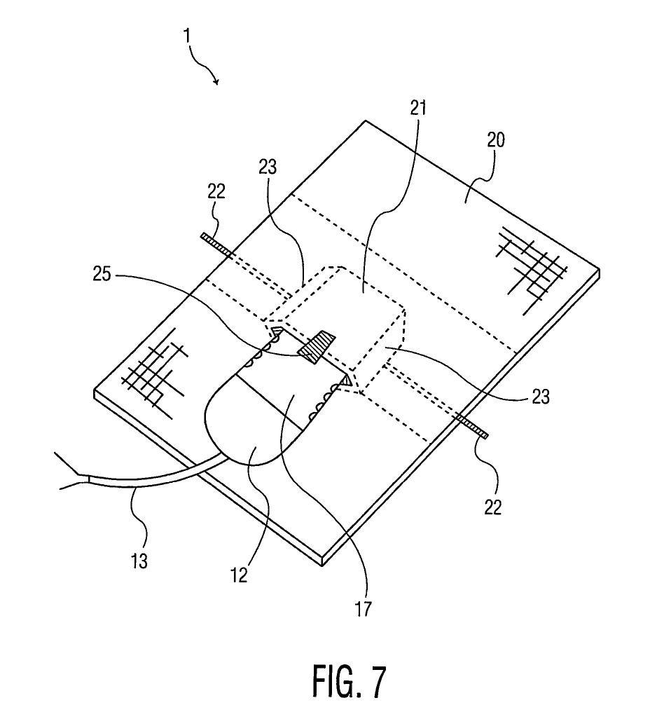

FIG. 7 is a perspective view of the male element of FIG. 5 and the female element of FIG. 3 interconnected; and

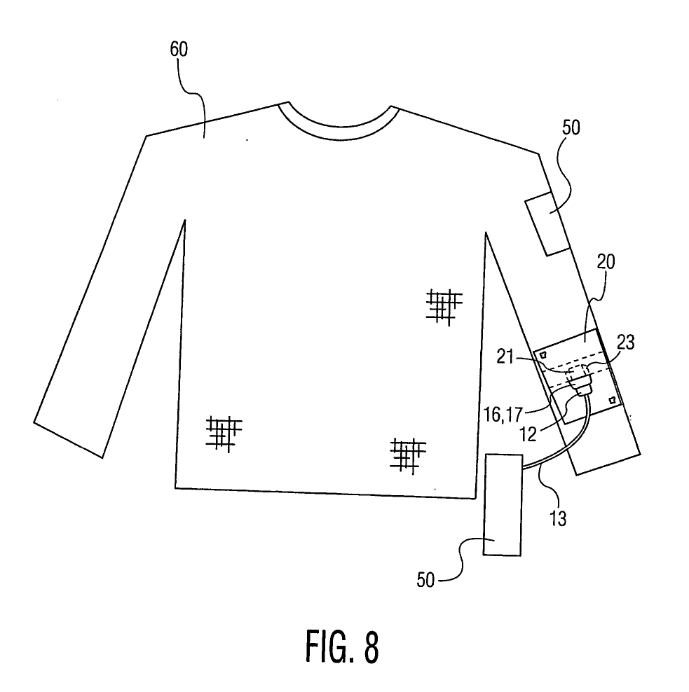

FIG. 8 is a plan view of a garment having a connecting assembly or an interconnect in accordance with an illustrative embodiment of the present invention.

Referring to the drawings and, in particular, FIG. 1, a connecting assembly or an interconnect in accordance with an illustrative embodiment of the present invention is shown and generally represented by reference numeral 1. Preferably, interconnect 1 has at least one male element 10 and at least one female element 20 cooperative with the at least one male element 10 to provide a secure and safe mechanical and/or electrical connection.

Referring to FIGS. 2 and 3, the at least one male element 10 preferably has one or more contact members 11 cooperative with at least one hub member 12. The at least one male element 10 also preferably having a connector 13 electrically and/or mechanically connectable with any of a variety of different electronic devices/systems. The connector 13 can have any configuration suitable to provide the means for this electrical communication.

Preferably, the one or more contact members 11 are each, at least in part, conductive and can be adjustable. For example, the one or more contact members 11 can be pivotally connected with the at least one hub member 12 so as to be pivotally adjusted between at least a first state 14 such as that shown in FIG. 2, and a second state 15 such as that shown in FIG. 3. Other configurations and/or arrangements of the one or more contact members 11 may also be used in order to accomplish a desired type of connection.

Further, the at least one hub member 12 can have at least one controller 16 for influencing the adjustment of the one or more contact members 11. Preferably, the at least one controller 16 is a bias control capable of managing a spring bias associated with the one or more contact members 11. For example, one or more contact members 11 can be biased to innately retract apart. Then, preferably the at least one controller 16 can operate to either directly or indirectly restrain the one or more contact members 11 against the innate bias thereof and/or, conversely, to directly or indirectly release the one or more contact members 11 from such restraint. It is noted that the restraint and/or release of the one or more contact members 11 may be accomplished incrementally in two or more steps, and/or immediately in a single step in order to accommodate any of a variety of different connection types.

The at least one male element 10, the at least one hub member 16 and/or the one or more contact members 11 preferably can be shaped, sized and/or configured to cooperate with any corresponding female element 20 to facilitate a safe and secure mechanical and/or electrical connection among and/or between various electronic devises/systems.

Referring to FIG. 4, the at least one female element 20 is preferably of a fiber or textile construction having at least one pocket or socket 21 for cooperating with the at least one male element 10, the at least one hub member 16 and/or the one or more contact members 11. The at least one female element 20 also preferably has one or more connectors 22 electrically and/or mechanically connectable with any of a variety of different electronic devices/systems. The one or more connectors 22 can have any configuration suitable to provide the means or way for this electrical communication. For example, the one or more connectors 22 can be of a fiber construction.

Preferably, the at least one socket 21 has one or more contact areas 23 associated therewith. Preferably, the one or more contact areas 23 are each, at least in part, conductive. More preferably, the conductive part of the one or more contact areas 23 is on an inner surface 24 of the socket 21. Even more preferably, the conductive part of the one or more contact areas 23 is along the periphery of the inner surface 24 to facilitate an effective electrical connection with the conductive part of the one or more contact members 11 of the at least one male element 10. For example, the one or more contact members 11 of the at least one male element 10, when in the second state 15 as shown in FIG. 3, can be engaged with the at least one socket 21 of the at least one female element 20. Then, once engaged, the one or more contact members 11 preferably can, when in the first state 14 as shown in FIG. 2, mechanically interact with the at least one socket 21 and/or electrically interact with the at least one socket 21 via the one or more contact members 11 and the one or more contact areas 23. Other configurations and/or arrangements may also be used in order to accomplish any of a variety of desirable types of connection.

The at least one female element 20 can preferably, among other things, facilitate communication with a power source 30 via the one or more connectors 22. Preferably, the at least one female element 20 and/or interconnect 1 can, in turn, facilitate power being provided to any of a variety of electronic devices/systems. The one or more connectors 22 preferably provide a medium for the electrical communication between any of a variety of devices/systems and/or power sources and the at least one female element 20.

The at least one female element 20, the at least one socket 21 and/or the one or more contact areas 23 can preferably have any shape, size and/or configuration suitable for cooperating with any corresponding male element 10 and to facilitate a safe and secure mechanical and/or electrical connection among and/or between various electronic devises/systems. For example, the at least one socket 21 can be collapsible such that when disengaged from the at least one male element 10, the one or more contact members 11, and/or the at least one hub member 12, the at least one socket 21 is hidden or substantially unnoticeable. In addition, the at least one socket 21 can preferably have one or more fasteners 25 for, such as for example, a Velcro arrangement, or a popper arrangement, or any similar type of securing arrangement sufficient to selectively hold the at least one socket 21 closed to prevent inadvertent access thereto.

The textile construction of the at least one female element 20 can preferably be fashioned from a variety of natural and/or manmade materials and/or any combination of materials using any known conventional method, such as for example, weaving, sewing or knitting metalized foils, conductive polymers, graphitized/metalized fibers, silicon, cotton, nylon, lycra, spandex, neoprene, polyester, and/or a rubber extruded fibers.

Referring to FIGS. 5 through 7, an interconnect in accordance with another illustrative embodiment of the present invention is shown and generally represented by reference numeral 2. In this illustrative embodiment, preferably the at least one controller 16 is a sliding accessory 17 that manages an innate spring bias associated with the one or more contact members 11. The sliding accessory 17 is preferably operative to either directly or indirectly restrain the one or more contact members 11 against the innate bias thereof and/or, conversely, to directly or indirectly release the one or more contact members 11 from such restraint. In this embodiment, as with the previous embodiment, the restraint and/or release of the one or more contact members 11 may be accomplished incrementally in two or more steps, and/or immediately in a single mechanical step in order to accommodate any of a variety of different connection types.

Further, as with the previous embodiment, the sliding accessory 17 preferably facilitates the one or more contact members 11 of the at least one male element 10 being pivotally adjusted between at least a first state 18, such as that shown in FIG. 5, and a second state 19, such as that shown in FIG. 6.

It is noted that other configurations and/or arrangements may also be used in order to facilitate a desired connection type. For example, the sliding accessory 17 can be configured to operatively connect with the one or more fasteners 25 of the at least one female element 20 to provide an additional security against any inadvertent disengagement of the at least one male element 10 and the at least one female element 20.

Thus, it should be apparent from the foregoing that the connecting assembly or interconnect 1 provided by the present invention can be any desired shape, size and/or configuration necessary to facilitate and/or accomplish various electronic operations, functions and/or applications corresponding with a variety of electronic devices/systems 50. Accordingly, the interconnect 1 is preferably a highly flexible/resilient, lightweight high-performance intuitive interconnect that can be integral with a variety of garments and/or upholstery 60 without compromising the innate characteristics or properties (e.g., comfort and/or durability) thereof.

The present invention having been thus described with particular reference to the preferred forms thereof, it will be obvious that various changes and modifications may be made therein without departing from the spirit of the present invention as defined herein.

What is claimed is:

1. An interconnect 1, comprising:
at least one male element (10) having one or more contact members (11); and
at least one female element (20) having one or more contact areas (23),
wherein said at least one female element (20) is fashioned from a flexible fiber construction.

2. The interconnect (1) of claim 1, wherein said one or more contact members (11) pivotally cooperate with at least one hub member (12).

3. The interconnect (1) of claim 2, wherein said one or more contact members (11) can cooperate with said one or more contact areas (23) of said at least one female element (20).

4. The interconnect (1) of claim 2, wherein said at least one hub member (12) has a controller (16) for cooperating with said one or more contact members (11).

5. The interconnect (1) of claim 4, wherein said controller (16) controls the pivotal positioning of said one or more contact members (11).

6. The interconnect (1) of claim 1, wherein said fiber construction of said at least one female element (20) forms a socket (21) with said one or more contact areas (23) being situated therein.

7. The interconnect (1) of claim 6, wherein said one or more contact members (11) are electrically and/or mechanically connectable with said socket and/or said one or more contact areas (23).

8. A garment or upholstery (60) having the interconnect (1) of claim 6.

9. The interconnect (1) of claim 6, wherein said socket (21) of said at least one female element (20) and said one or more contact members (11) of said at least one male element (10) are electrically and/or mechanically connectable with any of a variety of electronic devices/systems (50).

10. A connecting assembly 1, comprising:
at least one male element (10) having at least two contact members (11); and
at least one female element (20) having at least two contact areas (23),
wherein said at least one female element (20) is fashioned from a flexible fiber construction.

11. The connecting assembly (1) of claim 10, further comprising at least one hub member (12).

12. The connecting assembly (1) of claim 11, wherein said at least two contact members (11) pivotally cooperate with said at least one hub member (12).

13. The connecting assembly (1) of claim 12, wherein said at least two contact members (11) can interact with said at least two contact areas (23) of said at least one female element (20).

14. The connecting assembly (1) of claim 12, wherein said at least one hub member (12) has a controller (16) for cooperating with said at least two contact members (11).

15. The connecting assembly (1) of claim 14, wherein said controller (16) influences the pivotal positioning of said at least two contact members (11).

16. The connecting assembly (1) of claim 10, wherein the flexible fiber construction of said at least one female element (20) has at least one socket (21) with said at least two contact areas (23) being on and/or integral with a surface (24) of said at least one socket (21).

17. The connecting assembly (1) of claim 16, wherein said at least two contact members (11) are electrically and/or mechanically connectable with said at least one socket (21), said at least two contact areas (23), and/or one or more electronic devices/systems (50).

18. A garment or upholstery (60) having the connecting assembly (1) of claim 16.

19. A connecting assembly (1), comprising:
at least one male element (10) having one or more conductive contact members (11) with at least one accessory (17); and
at least one female element (20) having one or more conductive contact areas (23),
wherein said one or more contact members (11) are electrically and/or mechanically connectable with said one or more contact areas (23) and/or one or more electronic devices/systems.

20. The connecting assembly (1) of claim 19, wherein said accessory (17) facilitates said one or more conductive contact members (11) being adjusted between at least one first state (14, 18) and at least one second state (15, 19).
